(19) United States
(12) Patent Application Publication
(10) Pub. No.: US 2014/0150871 A1
(43) Pub. Date: Jun. 5, 2014

(54) SYSTEM AND METHOD FOR OFF-LOADING LIQUIDS FROM TANK TRAILERS

(71) Applicant: PARAGON TANK TRUCK EQUIPMENT, LLC, Milwaukee, WI (US)

(72) Inventor: Peter Charles Goodier, White, GA (US)

(73) Assignee: PARAGON TANK TRUCK EQUIPMENT, LLC, Milwaukee, WI (US)

(21) Appl. No.: 13/693,417

(22) Filed: Dec. 4, 2012

(51) Int. Cl. B60P 3/22

(52) U.S. Cl. CPC B60P 3/2245
USPC 137/1; 137/334

(57) ABSTRACT

A hydraulic system for off-loading liquids from a tank trailer includes a liquid pump and a compressor disposed within a housing. The liquid pump and the compressor are operated by hydraulic motors driven by an external hydraulic pump operatively coupled to a power take-off from a tractor. The hydraulic motors are in fluid communication with the hydraulic pump and with a hydraulic oil cooler that is likewise disposed within the housing. An actuator handle on a selection and/or direction valve permits an operator to select the liquid pump to off-load liquids that will not cause damage to the liquid pump by pumping the liquid from the tank trailer via a first liquid conduit through the liquid pump and via a second liquid conduit into a storage container. The actuator handle permits the operator to select the compressor to off-load liquids that can potentially cause damage to the liquid pump by pressurizing the tank trailer via a pneumatic line from the compressor and forcing the liquid via a liquid conduit into the storage container.

### FIELD OF THE INVENTION

The present invention relates to off-loading liquids from tank trailers. More specifically, the invention is a system and method for off-loading liquids from tank trailers using either a liquid pump or a compressor.

### BACKGROUND OF THE INVENTION

Bulk liquid tank trailers are well known for transporting liquids from a raw material processing plant and for off-loading the liquid into a storage container at a manufacturing facility. Depending on the discharge requirements of the liquid, one of two methods is typically utilized for off-loading the liquid from the tank trailer. Most liquids are suitable for being off-loaded using a liquid pump that draws the liquid from the interior of the tank trailer through a liquid conduit connected between a discharge connection on the trailer and an intake connection on the pump, and then delivers the liquid to the storage container through another liquid conduit connected between an outtake connection on the pump and an intake connection on the storage container. Certain liquids, for example corrosive and/or abrasive liquid chemicals, are more suitable for being off-loaded using a compressor that pressurizes the interior of the tank trailer with a pneumatic line from the compressor to a pneumatic intake connection on the trailer. The increased head pressure in the tank trailer forces the liquid through a liquid conduit connected between the discharge connection on the tank trailer and the intake connection on the storage container so that the liquid pump is not potentially damaged by the corrosive and/or abrasive liquid chemical. A compressor may also be used to pressurize the interior of a tank trailer in the same manner to assist the flow of a non-corrosive and non-abrasive liquid through the liquid pump and into the storage container.

The discharge equipment needed to off-load a liquid from a bulk liquid tank trailer is typically located on the tank truck, which is also commonly referred to as the “tractor.” The discharge equipment is located on the tractor so as to be conveniently and permanently coupled to the power take-off (PTO) of the tractor. The discharge equipment commonly used to pump a liquid from a tank trailer into a storage container includes a PTO operatively coupled to the transmission of the tractor, a drive shaft operatively coupled to the PTO, and a liquid pump operatively coupled to the drive shaft. As previously described, the liquid pump is connected by liquid conduits that extend between the tank trailer and the liquid pump, and between the liquid pump and the storage container. The discharge equipment commonly used to pressurize a bulk liquid tank trailer and to off-load a liquid directly into a storage container includes a PTO operatively coupled to the transmission of the tractor, a drive shaft operatively coupled to the PTO, and an oil-free or oil-lubricated compressor operatively coupled to the drive shaft. As previously described, the compressor is connected by a pneumatic line that extends between the compressor and the tank trailer, and a liquid conduit that extends between the tank trailer and the storage container.

At times, the same tractor may haul different tank trailers transporting different liquids that can be off-loaded using a liquid pump or that must be off-loaded using a compressor. At other times, the same tractor may haul the same tank trailer transporting different liquids that can be off-loaded using a liquid pump or that must be off-loaded using a compressor. Accordingly, it is known to provide a tractor with the discharge equipment necessary to off-load different liquids using either a liquid pump or a compressor. In particular, it is typical for a tractor to be provided with both a liquid pump for off-loading non-corrosive and non-abrasive liquids, and a compressor for off-loading corrosive and/or abrasive liquids. In such instances, the liquid pump and the compressor are each operatively coupled to a drive shaft that is in turn coupled to the PTO of the tractor, or alternatively, to a hydraulic drive system coupled to the PTO.

Many of the disadvantages associated with the use of a mechanical drive shaft powered by the PTO from a tractor to operate the discharge equipment are overcome by using a hydraulic drive system powered by the PTO from the tractor. With a hydraulic drive system there is no direct connection to the motive power provided by the PTO from the truck engine. Instead, a hydraulic pump operatively coupled to the PTO pumps hydraulic fluid, also known as hydraulic oil, to a hydraulic motor, which in turn operates the liquid pump and the compressor. As a result, the hydraulic pressure produced by the hydraulic pump is directly proportional to the horsepower requirements of the liquid pump or compressor. Proper sizing of the hydraulic components, and in particular the hydraulic pump and hydraulic motors, will cause the hydraulic drive system to initially operate the liquid pump and compressor at the appropriate speed and/or pressure. Another advantage of a hydraulically driven liquid pump or compressor is the elimination of potentially dangerous rotating shafts that are typically exposed with a mechanical drive shaft coupled to a PTO from a tractor, as well as any concern associated with alignment of the shafts. Further benefits of a hydraulic drive system over a mechanical drive shaft include slower start-up, and emergency shutdown capability.

Existing hydraulic drive systems are useable for operating a liquid pump to off-load liquids that do not cause damage to the liquid pump, as well as for operating a compressor to off-load liquids that could potentially damage the liquid pump. As previously mentioned, it is desirable to provide both a liquid pump and a compressor on the same tractor to off-load liquids having different discharge requirements. Oftentimes, however, there is only limited space available on the tractor frame for separately mounting a liquid pump and a compressor at convenient locations. Furthermore, providing both a liquid pump and a compressor on the same tractor creates a complex network of connections with the hydraulic drive system, as well as with any necessary selection and/or direction, back-flow, check and relief valves, couplings and hydraulic fluid lines associated with the liquid pump and the compressor. In addition to the complexity of the hydraulic connections, physical separation of the liquid pump and the compressor results in a corresponding loss of efficiency and reliability.

Accordingly, despite the existence of hydraulic systems for operating discharge equipment mounted on a tractor for off-loading liquids from a tank trailer using either a liquid pump or a compressor, a need remains for an improved system and method for off-loading liquids having different discharge requirements from tank trailers. A more specific need exists for a hydraulic system and method for off-loading liquids from tank trailers that overcomes the disadvantages and deficiencies of a liquid pump and a compressor that are mounted separately on a tractor and separately connected to a hydraulic pump and hydraulic oil cooler by independent hydraulic fluid lines. There exists a further and more particular need for a hydraulic system and method including a liquid pump and a compressor for off-loading different liquids from tank trailers that is configured to be mounted as a single unit at a convenient location on a tractor, or alternatively, on a tank trailer. There exists a still further and more particular need for a hydraulic system and method that eliminates the need for a separately mounted liquid pump, compressor, hydraulic oil cooler, hydraulic reservoir, hydraulic relief valve, hydraulic filter or self contained hydraulic cooler pack, and consequently reduces the number of corresponding hydraulic fluid line connections to thereby reduce the complexity of the hydraulic system, while increasing the efficiency and reliability of the hydraulic system.

### BRIEF DESCRIPTION OF THE DRAWINGS

The following detailed description of the invention is best understood with reference to the accompanying drawing figures in which one or more exemplary embodiments of the invention are illustrated and wherein like reference numerals denote like elements throughout the various views:

FIG. 1 is an elevation view illustrating a first method for off-loading a non-corrosive and non-abrasive liquid from a tank trailer into a storage container according to the invention.

FIG. 2 is an elevation view illustrating a second method for off-loading a corrosive and/or abrasive liquid from a tank trailer into a storage container according to the invention.

FIG. 3 is a perspective view showing the components of a typical prior art hydraulic system for off-loading a liquid from a tank trailer.

FIG. 4 is a schematic diagram illustrating a typical arrangement of the components and the hydraulic fluid line connections of the prior art hydraulic system of FIG. 3.

FIG. 5 is a left-hand perspective view showing a hydraulic system configured for off-loading a liquid from a tank trailer according to the invention.

FIG. 6 is a right-hand perspective view of the hydraulic system shown in FIG. 5.

FIG. 7 is a right-hand perspective view of the hydraulic system shown in FIG. 5 with the cover of the housing removed to illustrate an exemplary embodiment of an arrangement of the components of the hydraulic system disposed within the housing.

FIG. 8 is a schematic diagram illustrating an exemplary embodiment of the components and the hydraulic fluid line connections of the hydraulic system of FIG. 5.

FIG. 8A is a schematic diagram illustrating an exemplary embodiment of the components and the hydraulic fluid line connections of the hydraulic system of FIG. 5 including an oil-lubricated compressor.

### DETAILED DESCRIPTION OF THE INVENTION

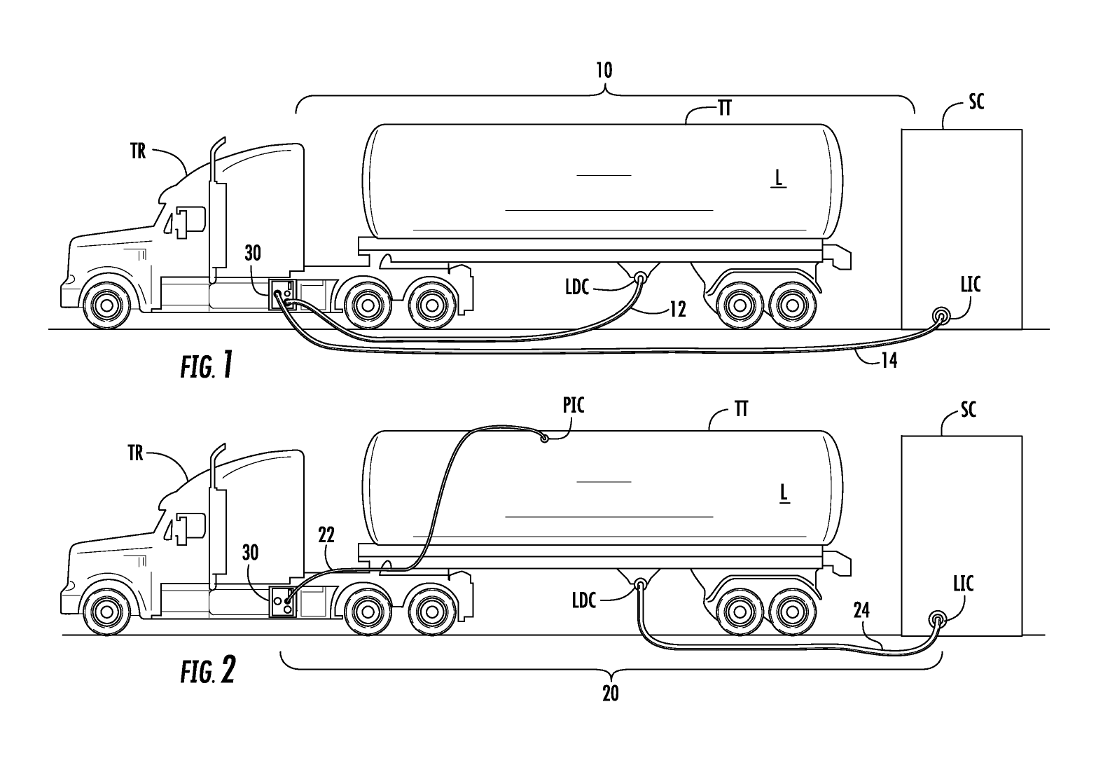

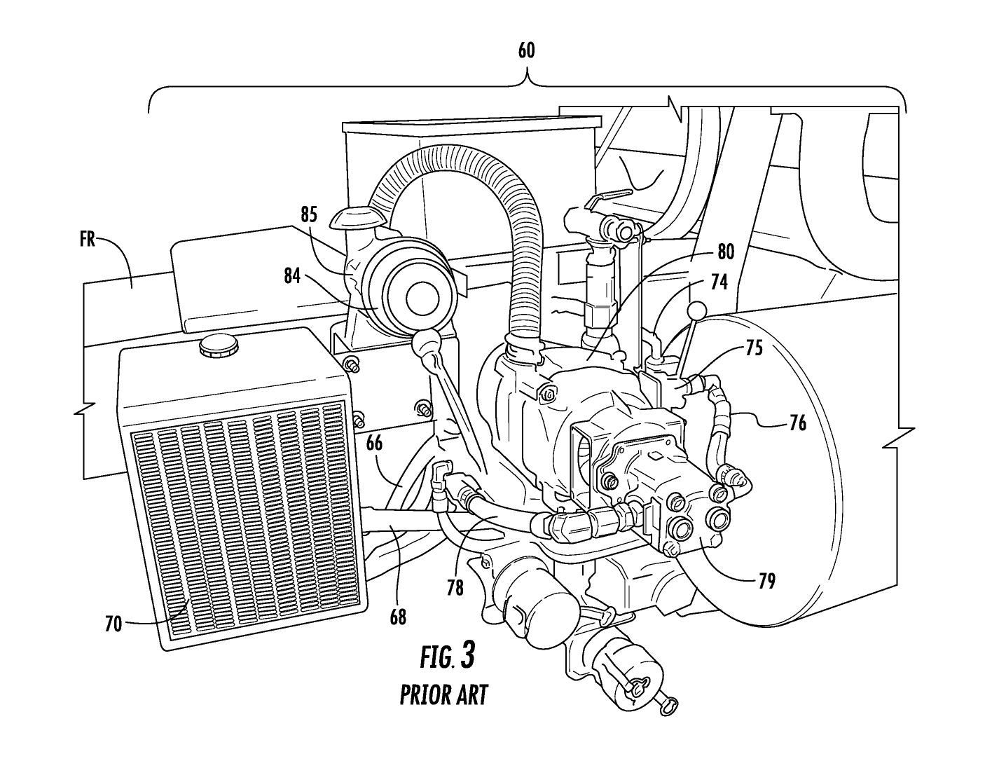

Referring now to the accompanying drawing figures, FIG. 1 and FIG. 2, respectively, illustrate alternative methods for off-loading a liquid from a tank trailer according to the invention. A conventional tank trailer, indicated generally at TT, is attached to a tank truck, or tractor, TR for transporting a liquid L contained within the tank trailer from, for example, a raw material processing plant and for off-loading the liquid into a storage container SC located at, for example, a manufacturing facility. In a first method, the liquid L is a liquid that will not cause damage to a liquid pump of a discharge system. In a second method, the liquid L is a liquid that could potentially cause damage to the liquid pump of the discharge system, such as a corrosive and/or abrasive liquid.

FIG. 1 illustrates a first method 10 for off-loading the liquid L from the tank trailer TT into the storage container SC. An exemplary embodiment of the first method 10 comprises mounting a hydraulically driven liquid discharge system 30 according to the invention at a convenient location on the tractor TR. Alternatively, the hydraulic system 30 could be mounted at a convenient location on the tank trailer TT. However, it is typically more desirable to mount the hydraulic system 30 on the tractor TR so as to shorten and reduce the complexity of the associated hydraulic and pneumatic lines. Furthermore, an advantage of the present invention is that the hydraulic system 30 is useable with the same or different tank trailers TT for off-loading liquids that can be discharged using a liquid pump, as well as for off-loading liquids that could potentially damage the liquid pump. Regardless, the first method 10 further comprises connecting the hydraulic system 30 in fluid communication with the tank trailer TT by routing a first liquid conduit 12 between a liquid discharge connection LDC, such as a valve or coupling, typically located on the underside of the tank trailer TT, and a liquid intake connection (not shown) provided on the hydraulic system. First method 10 further comprises connecting the hydraulic system 30 in fluid communication with the storage container SC by routing a second liquid conduit 14 between a liquid outtake connection (not shown) provided on the hydraulic system and a liquid intake connection LIC, such as a valve or coupling, provided on the storage container. The first method 10 further comprises using a liquid pump (not shown) of the hydraulic system 30 to draw the liquid L from the tank trailer TT through the first liquid conduit 12, and to pump the liquid L through the second liquid conduit 14 into the storage container SC. Preferably, the first method 10 is used for off-loading liquids L that will not cause damage to the liquid pump of the hydraulic system 30, such as liquids that are non-corrosive and non-abrasive.

FIG. 2 illustrates a second method 20 for off-loading a liquid L from the tank trailer TT into the storage container SC. An exemplary embodiment of the second method 20 comprises mounting a hydraulically driven liquid discharge system 30 according to the invention at a convenient location on the tractor TR. Alternatively, the hydraulic system 30 could be mounted at a convenient location on the tank trailer TT. However, it is typically more desirable to mount the hydraulic system 30 on the tractor TR so as to shorten and reduce the complexity of the associated hydraulic and pneumatic lines. Furthermore, an advantage of the present invention is that the hydraulic system 30 is useable with the same or different tank trailers TT for off-loading liquids L that can be discharged using a liquid pump, as well as for off-loading liquids L that could potentially damage the liquid pump. Regardless, the second method 20 further comprises connecting the hydraulic system 30 in pneumatic communication with the tank trailer TT by routing a pneumatic line 22 between a pneumatic outtake connection provided on the hydraulic system and a pneumatic intake connection PIC, such as a valve or coupling, typically located on the topside of the tank trailer TT. Second method 20 further comprises connecting the tank trailer TT in fluid communication with the storage container SC by routing a liquid conduit 24 between the liquid discharge connection LDC provided on the tank trailer and the liquid intake connection LIC provided on the storage container. The second method 20 further comprises using a compressor (not shown) of the hydraulic system 30 to pressurize the interior of the tank trailer TT through the pneumatic line 22 and to force the liquid L through the liquid conduit 24 into the storage container SC. Preferably, the second method 20 is used for off-loading liquids L that could potentially damage the liquid pump of the hydraulic system 30, such as liquids that are corrosive and/or abrasive.

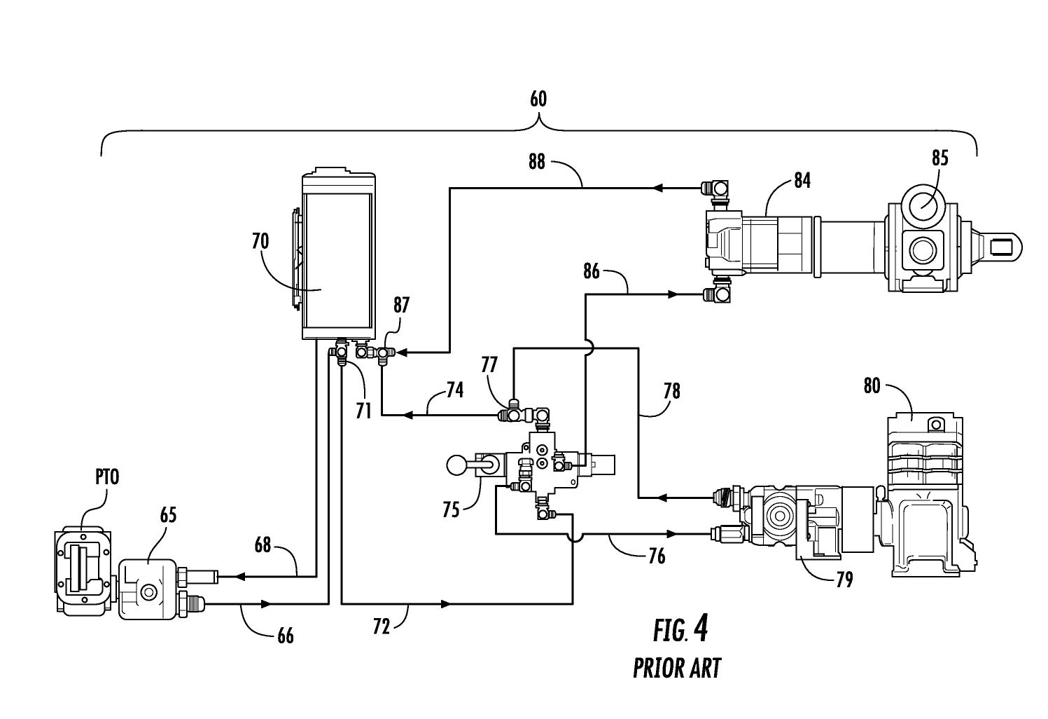

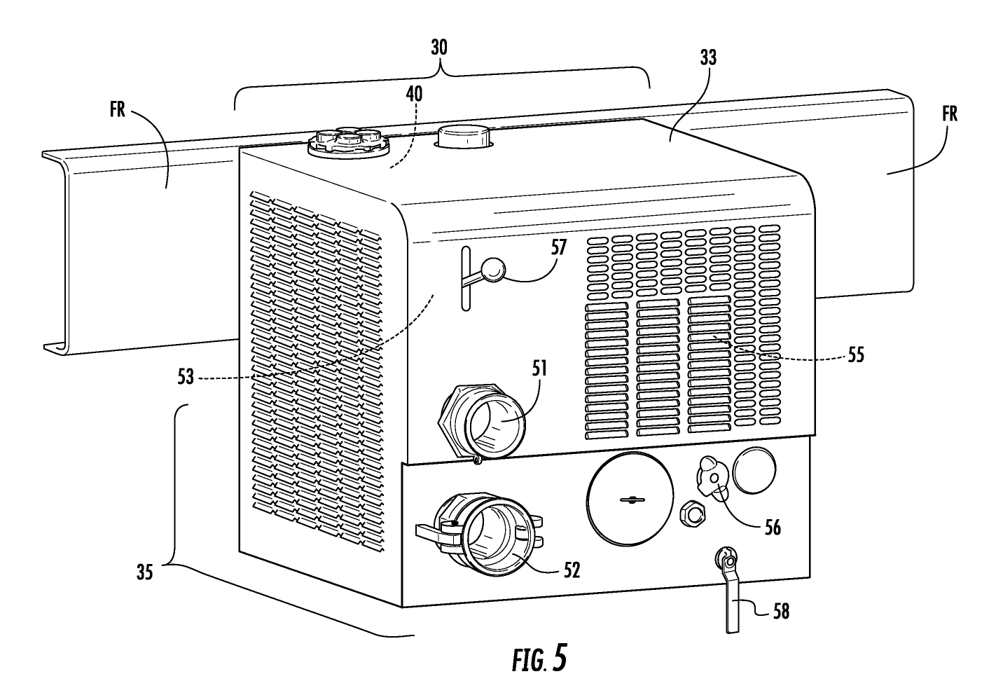

FIG. 3 shows the components of a typical prior art hydraulic system 60 comprising hydraulically driven liquid discharge equipment for off-loading a liquid L from a tank trailer TT attached to a tank truck, or tractor, TR. FIG. 4 illustrates a typical arrangement for the components and the hydraulic fluid connections of the prior art hydraulic system 60 shown in FIG. 3. The components of the hydraulic system 60 are mounted on the tractor TR so that the tractor can be used with the same or different tank trailers TT for off-loading liquids L that are can be discharged using a liquid pump 85, as well as for off-loading liquids that must be discharged using a compressor 80. As shown, hydraulic system 60 comprises a hydraulic pump 65 (FIG. 4) operatively coupled by a direct drive connection to the power take-off PTO of the tractor TR. The power take-off PTO is in turn operatively coupled to the transmission (not shown) of the tractor TR in a known manner. The hydraulic pump 65 is in fluid communication with hydraulic oil cooler 70 via a high pressure hydraulic fluid outtake line 66 and a low pressure hydraulic fluid suction line 68. As shown in FIG. 3, hydraulic oil cooler 70 is mounted to a frame rail FR of the tractor TR. A hydraulic oil cooler 70 having sufficient capacity and suitable performance for use with the hydraulically driven components of hydraulic system 60 is the HydraFLOW™ hydraulic oil cooler commercially available from Paragon Tank Truck Equipment, LLC of Cartersville, Ga., USA.

Hydraulic oil cooler 70 is also in fluid communication with a selection and/or direction valve 75 via a hydraulic fluid intake line 72 and a hydraulic fluid return (outtake) line 74. Valve 75 is in fluid communication with a hydraulic motor 79 of a compressor 80 via a hydraulic fluid intake line 76 and a hydraulic fluid return (outtake) line 78. Selection and/or direction valve 75 is likewise in fluid communication with a hydraulic motor 84 of a liquid pump 85 via a hydraulic fluid intake line 86, while the hydraulic motor 84 of the liquid pump 85 is in direct fluid communication with hydraulic oil cooler 70 via a hydraulic fluid return (outtake) line 88. As shown, high pressure outtake line 66 and intake line 72 are interconnected at tee-valve 71. Similarly, return (outtake) line 74 and return (outtake) line 78 are interconnected at tee-valve 77, while return (outtake) line 74 and return (outtake) line 88 are interconnected at tee-valve 87. As best seen with reference to FIG. 3, each of the several components of the prior art hydraulic system 60 is mounted separately to the frame rail FR of the tractor TR, or alternatively, to a structural element that is mounted to the frame rail of the tractor. Consequently, routing the hydraulic fluid lines of the hydraulic system 60 is significantly complex. As such, it is oftentimes difficult to isolate a particular hydraulic line for maintenance and repair. In addition, the physical separation of the components and the complex routing of the hydraulic fluid lines increase the length of the hydraulic fluid lines and the number of fluid connections (e.g. valves, couplings, etc.) necessary to interconnect the several components in fluid communication with one another. Each of the above concerns incrementally adds to the acquisition and operating costs of the hydraulic system 60, while reducing its overall efficiency and reliability.

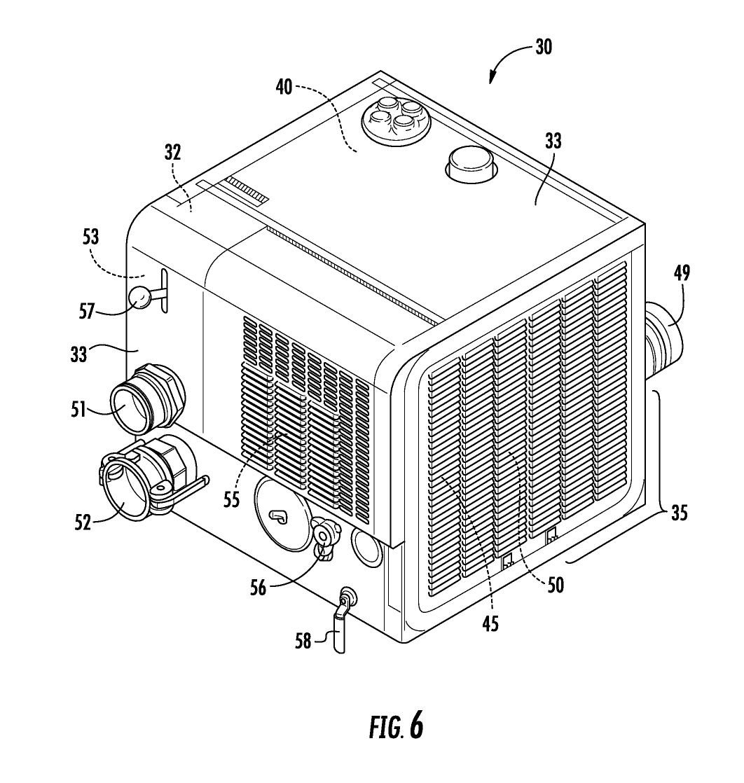

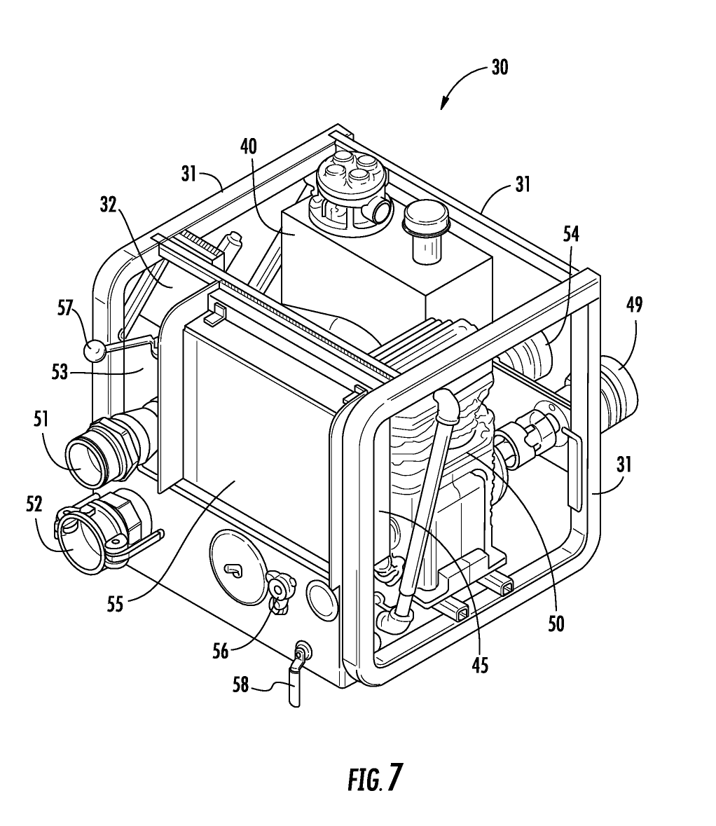

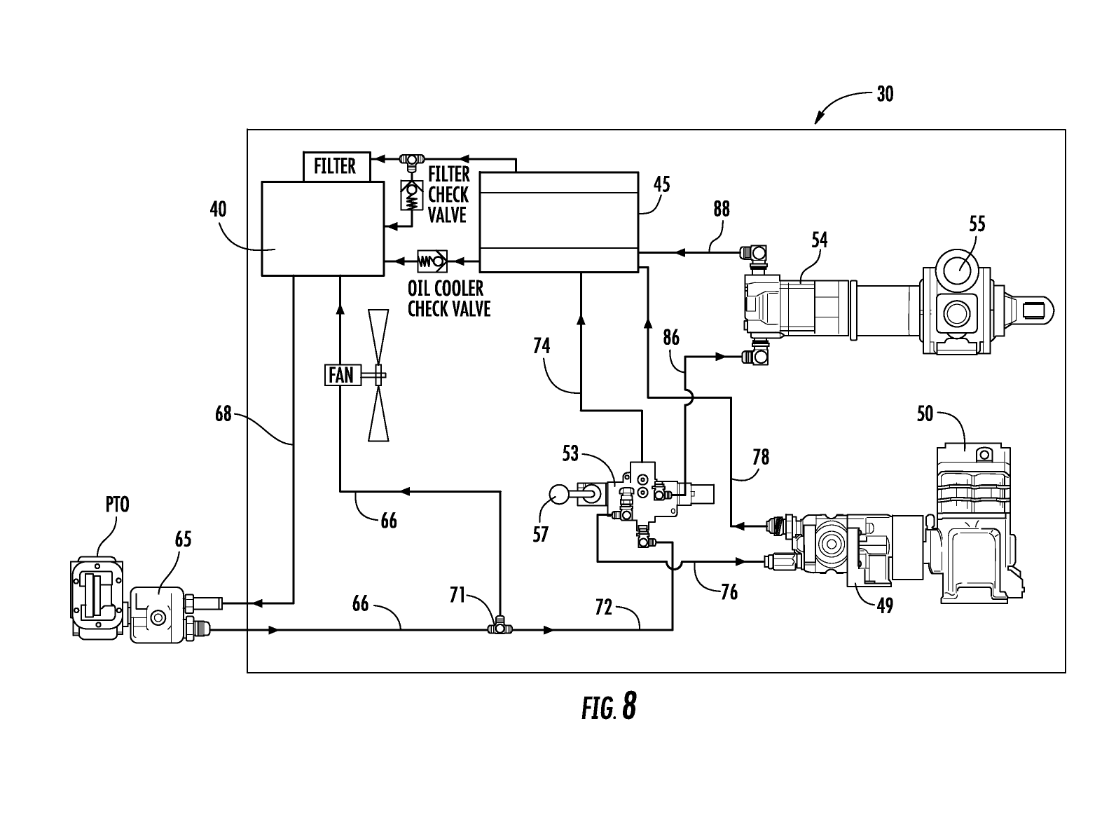

FIGS. 5-7 show a hydraulically driven liquid discharge system 30 according to the invention for off-loading liquids from a tank trailer using either a liquid pump 55 or a compressor 50. Hydraulic system 30 comprises a housing 35 defined by an internal frame 31 (FIG. 7) for supporting the components of the hydraulic system and an external cover 33 configured for encasing and enclosing the components. Frame 31 is mounted at a convenient location on a frame rail FR of a tank truck, or tractor, by any known suitable means, such as with mechanical fasteners or by welding. Cover 33 is formed by a plurality of relatively thin panels that are joined together by snap-fittings, quick-release fasteners or the like to provide ready access to the internal components of the hydraulic system 30 supported on frame 31. As previously described with reference to prior art hydraulic system 60, hydraulic system 30 may be powered by hydraulic pump 65 operatively coupled to the power take-off PTO from the tractor TR. However, the invention is not intended to be limited in any manner by the source of power for operating the hydraulic system 30. It is envisioned that a hydraulic system 30 according to the invention may be powered by any other suitable source of power, including by way of example and not by way of limitation, an electric motor and hydraulic pump, or alternatively, an auxiliary gasoline or diesel engine and hydraulic pump. For purposes of illustration only, hydraulic system 30 is described herein as being hydraulically driven by hydraulic pump 65 that is operatively coupled by a direct drive connection to the power take-off PTO from the tractor TR.

Hydraulic pump 65 pumps hydraulic fluid (oil) through a high pressure hydraulic fluid outtake line connected between the hydraulic pump and a hydraulic fluid intake connection 32 (FIG. 7) provided on frame 31 of hydraulic system 30. Hydraulic fluid intake connection 32 is preferably positioned on frame 31 at a convenient location for access from the exterior of the frame rail FR of tractor TR. Intake connection 32 is operatively coupled to a selection and/or direction valve 53 that is secured on frame 31 and disposed at least partially within cover 33 such that the selection and/or direction valve is in fluid communication with hydraulic pump 65. In turn, selection and/or direction valve 53 is in fluid communication with a hydraulic motor 54 (FIG. 7) that drives the liquid pump 55 in the manner previously described with respect to prior art hydraulic system 60. A hydraulic oil cooler 45 (FIG. 7) mounted on frame 31 and disposed within cover 33 is in fluid communication with a hydraulic oil tank 40 that is likewise secured on the frame and disposed within the cover of the housing 35. The hydraulic oil tank 40 is in fluid communication with hydraulic pump 65 via a fluid outtake connection (not shown) preferably located adjacent the bottom of the oil tank, for example on the underside. A hydraulic motor 49 for operating compressor 50 mounted on the frame 31 is operatively coupled, for example, via a tee-valve, to the selection and/or direction valve 53. Similarly, the hydraulic motor 54 for operating liquid pump 55 mounted on frame 31 is operatively coupled to the selection and/or direction valve 53 via the tee-valve. Both the hydraulic motor 54 that drives the liquid pump 55 and the hydraulic motor 49 that drives the compressor 50 are provided with hydraulic fluid return (outtake) lines so that both of the hydraulic motors are in fluid communication with the hydraulic oil cooler 45.

The liquid pump 55 has a liquid intake connection 52, such as a conventional liquid coupling, configured to receive a free end of the liquid conduit 12 that is connected between the liquid discharge connection LDC provided on the tank trailer TT and the liquid pump, as illustrated in FIG. 1. The liquid pump further has a liquid outtake connection 51, such as a conventional liquid coupling, configured to receive a free end of the liquid conduit 14 that is connected between the liquid pump and the liquid intake connection LIC provided on the storage container SC, as illustrated in FIG. 1. Similarly, the compressor 50 has a pneumatic outtake connection 56 configured to received a free end of the pneumatic line 22 connected between the compressor and the pneumatic intake connection PIC provided on the tank trailer TT, as illustrated in FIG. 2. A lever 58 is provided on the housing 35 of the hydraulic system 30 for opening a valve to permit compressed air to be delivered through pneumatic line 22 to the tank trailer TT and for closing the valve to prevent compressed air from being delivered to the tank trailer. Furthermore, selection and/or direction valve 53 has an actuator handle 57 that extends outwardly from the housing 35 for permitting an operator to select the operation of the hydraulic system 30 between the liquid pump 55 and the compressor 50. The operator selects the liquid pump 55 of the hydraulic system 30 to off-load liquids that will not cause damage to the liquid pump in the manner of the first method 10 illustrated in FIG. 1. Conversely, the operator selects the compressor 50 of the hydraulic system 30 to off-load liquids that could potentially cause damage to the liquid pump 55 in the manner of the second method 20 illustrated in FIG. 2. In addition, the actuator handle 57 of the selection and/or direction valve 53 may be configured to permit an operator to control the speed of the liquid pump 55 for off-loading a liquid that is sensitive to a shear force. Furthermore, the actuator handle 57 of the selection and/or direction valve 53 may be configured to permit an operator to select the direction of a bi-directional liquid pump 55.

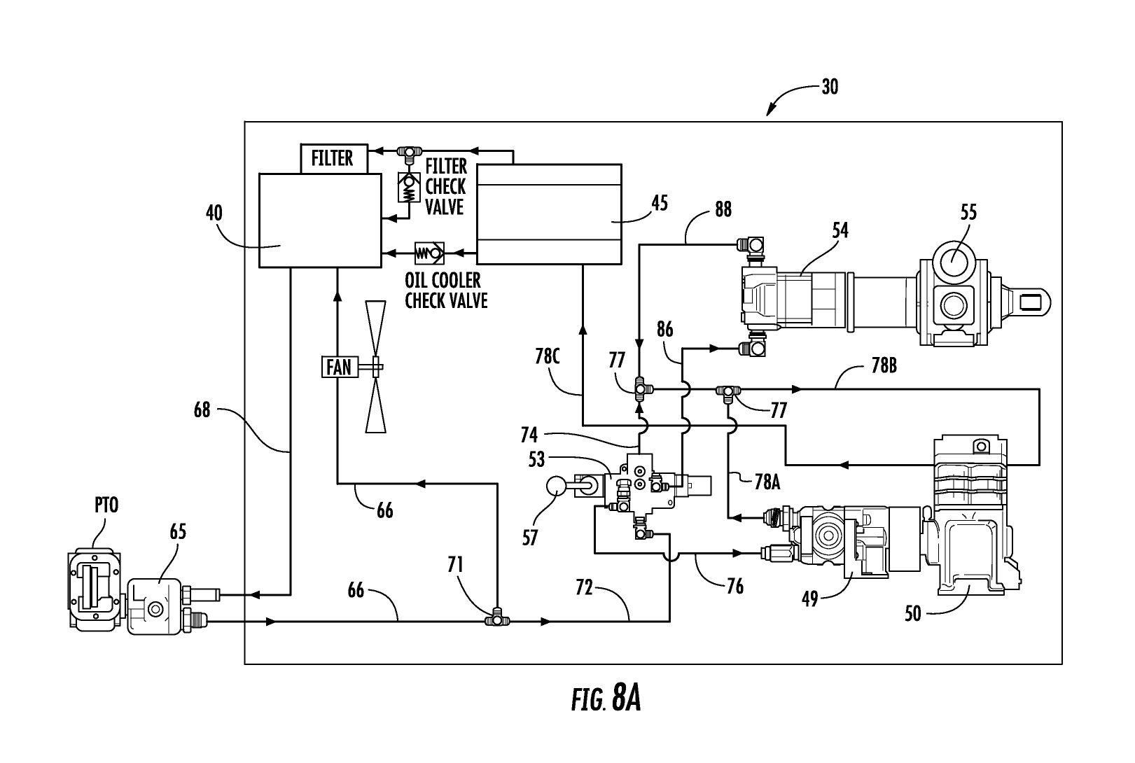

FIG. 8 illustrates an exemplary embodiment of an arrangement of the components and the hydraulic fluid line connections of the hydraulic system 30. The components of the hydraulic system 30 are mounted on the frame 31 of housing 35 and the housing is mounted to a frame rail FR of the tractor TR so that the tractor can be used with the same or different tank trailers TT for off-loading liquids L that are can be discharged using liquid pump 55, as well as for off-loading liquids that must be discharged using compressor 50. As previously described, hydraulic system 30 is hydraulically driven by hydraulic pump 65 operatively coupled by a direct drive connection to the power take-off PTO from a tractor TR, which is in turn operatively coupled to the transmission of the tractor TR in a known manner. The hydraulic pump 65 is in fluid communication with hydraulic oil tank 40 via high pressure hydraulic fluid outtake line 66 (optionally through a conventional fan) and via low pressure hydraulic fluid suction line 68. In turn, the hydraulic oil tank 40 is in fluid communication with the hydraulic oil cooler 45 through, for example, a conventional hydraulic oil filter, oil filter check valve and oil cooler check valve, via corresponding hydraulic fluid lines. A hydraulic oil cooler 45 having sufficient capacity and suitable performance for use with the hydraulically driven components of hydraulic system 30 is the HydraFLOW™ hydraulic oil cooler commercially available from Paragon Tank Truck Equipment, LLC of Cartersville, Ga., USA.

Hydraulic pump 65 is also in fluid communication with selection and/or direction valve 53 through tee-valve 71 via hydraulic fluid intake line 72. Selection and/or direction valve 53 is in direct fluid communication with hydraulic oil cooler 45 via hydraulic fluid return (outtake) line 74. Valve 53 is also in fluid communication with the hydraulic motor 49 of compressor 50 via hydraulic fluid intake line 76, while the hydraulic motor 49 of compressor 50 is in direct fluid communication with hydraulic oil cooler 45 via hydraulic fluid return (outtake) line 78. Valve 53 is likewise in fluid communication with the hydraulic motor 54 of liquid pump 55 via hydraulic fluid intake line 86, while the hydraulic motor 54 of liquid pump 55 is in direct fluid communication with hydraulic oil cooler 45 via hydraulic fluid return (outtake) line 88. As shown, high pressure outtake line 66 and hydraulic fluid intake line 72 are interconnected at tee-valve 71. As previously mentioned, each of the several components of hydraulic system 30 is mounted to the frame 31 of housing 35, which is in turn mounted to the frame rail FR of the tractor TR. Consequently, routing the hydraulic fluid lines between the components 40, 45, 53, 49 and 54 of the hydraulic system 30 is significantly simplified. As such, it is relatively easy to isolate a particular hydraulic line for maintenance and repair. In addition, the physical separation of the components and the simplified routing of the hydraulic fluid lines reduce the length of the hydraulic fluid lines and the number of fluid connections (e.g. valves, couplings, etc.) necessary to interconnect the several components in fluid communication with one another. As a result, the acquisition and operating costs of the hydraulic system 30 are substantially reduced, while the overall efficiency and reliability of the hydraulic system 30 is significantly improved, as compared to the prior art hydraulic system 60.

FIG. 8A illustrates an exemplary embodiment of an arrangement of the components and the hydraulic fluid line connections of the hydraulic system 30 including an oil-lubricated compressor 50. The components of the hydraulic system 30 are mounted on the frame 31 of housing 35 and the housing is mounted to a frame rail FR of the tractor TR so that the tractor can be used with the same or different tank trailers TT for off-loading liquids L that are can be discharged using liquid pump 55, as well as for off-loading liquids that must be discharged using compressor 50. As previously described, hydraulic system 30 is hydraulically driven by hydraulic pump 65 operatively coupled by a direct drive connection to the power take-off PTO from a tractor TR, which is in turn operatively coupled to the transmission of the tractor TR in a known manner. The hydraulic pump 65 is in fluid communication with hydraulic oil tank 40 via high pressure hydraulic fluid outtake line 66 (optionally through a conventional fan) and via low pressure hydraulic fluid suction line 68. In turn, the hydraulic oil tank 40 is in fluid communication with the hydraulic oil cooler 45 through, for example, a conventional hydraulic oil filter, oil filter check valve and oil cooler check valve, via corresponding hydraulic fluid lines. A hydraulic oil cooler 45 having sufficient capacity and suitable performance for use with the hydraulically driven components of hydraulic system 30 is the HydraFLOW™ hydraulic oil cooler commercially available from Paragon Tank Truck Equipment, LLC of Cartersville, Ga., USA.

Hydraulic pump 65 is also in fluid communication with selection and/or direction valve 53 through tee-valve 71 via hydraulic fluid intake line 72. Selection and/or direction valve 53 is in indirect fluid communication with hydraulic oil cooler 45 via hydraulic fluid return (outtake) line 74 through a first tee-valve 77. Valve 53 is also in fluid communication with the hydraulic motor 49 of compressor 50 via hydraulic fluid intake line 76, while the hydraulic motor 49 of compressor 50 is in indirect fluid communication with hydraulic oil cooler 45 via hydraulic fluid return (outtake) line 78A through a second tee-valve 77, and subsequently via hydraulic fluid return (outtake) lines 78B and 78C. Valve 53 is likewise in fluid communication with the hydraulic motor 54 of liquid pump 55 via hydraulic fluid intake line 86, while the hydraulic motor 54 of liquid pump 55 is in indirect fluid communication with hydraulic oil cooler 45 via hydraulic fluid return (outtake) line 88 through first tee-valve 77. The selection and/or direction valve 53 and the hydraulic motor 54 of the liquid ump 55 are each subsequently in indirect fluid communication with the hydraulic oil cooler 45 through second tee-valve 77 via hydraulic fluid return (outtake) lines 78B and 78C. It should be noted that hydraulic fluid return (outtake) lines 78B and 78C form a hydraulic oil lubrication circuit for the compressor 50. Also as shown, high pressure outtake line 66 and hydraulic fluid intake line 72 are interconnected at tee-valve 71. As previously mentioned, each of the several components of hydraulic system 30 is mounted to the frame 31 of housing 35, which is in turn mounted to the frame rail FR of the tractor TR. Consequently, routing the hydraulic fluid lines between the components 40, 45, 53, 49, 54 and 50 of the hydraulic system 30 is significantly simplified. As such, it is relatively easy to isolate a particular hydraulic line for maintenance and repair. In addition, the physical separation of the components and the simplified routing of the hydraulic fluid lines reduce the length of the hydraulic fluid lines and the number of fluid connections (e.g. valves, couplings, etc.) necessary to interconnect the several components in fluid communication with one another. As a result, the acquisition and operating costs of the hydraulic system 30 are substantially reduced, while the overall efficiency and reliability of the hydraulic system 30 is significantly improved, as compared to the prior art hydraulic system 60.

That which is claimed is:

1. A hydraulic system for off-loading liquids from a tank trailer, comprising:
a housing;
a liquid pump disposed within the housing, the liquid pump having a hydraulic motor for operating the liquid pump;
a compressor disposed within the housing, the compressor having a hydraulic motor for operating the compressor; and
a hydraulic oil cooler disposed within the housing, the hydraulic oil cooler being in fluid communication with the hydraulic motor of the liquid pump and with the hydraulic motor of the compressor.

2. A hydraulic system according to claim 1, wherein the hydraulic oil cooler is further in fluid communication with an external hydraulic pump.

3. A hydraulic system according to claim 2, wherein the hydraulic pump delivers hydraulic fluid to the hydraulic motor of the liquid pump and to the hydraulic motor of the compressor, and wherein the hydraulic fluid is returned to the hydraulic pump from the hydraulic oil cooler.

4. A hydraulic system according to claim 1, further comprising a liquid intake connection configured to receive a first liquid conduit connected between a liquid discharge connection provided on a tanker trailer and the liquid pump.

5. A hydraulic system according to claim 4, further comprising a liquid outtake connection configured to receive a second liquid conduit connected between the liquid pump and a liquid intake connection provided on a storage container.

6. A hydraulic system according to claim 1, further comprising a pneumatic outtake connection configured to receive a pneumatic line connected between the compressor and a pneumatic intake connection provided on a tanker trailer.

7. A hydraulic system according to claim 6, further comprising a liquid conduit connected between a liquid discharge connection provided on the tanker trailer and a liquid intake connection provided on a storage container.

8. A hydraulic system according to claim 1, further comprising a selection and/or direction valve disposed at least partially within the housing and operatively coupled to the hydraulic motor of the liquid pump and to the hydraulic motor of the compressor.

9. A hydraulic system according to claim 8, wherein the selection and/or direction valve has an actuator handle for permitting an operator to select operation of the hydraulic system between the liquid pump and the compressor.

10. A hydraulic system according to claim 9, wherein the actuator handle of the selection and/or direction valve is configured to permit the operator to control the speed of the liquid pump.

11. A hydraulic system according to claim 9, wherein the actuator handle of the selection and/or direction valve is configured to permit the operator to select the direction of a bi-directional liquid pump.

12. A hydraulic system according to claim 1, further comprising a lever for opening a valve to permit compressed air to be delivered from the compressor via a pneumatic line to a tank trailer and for closing the valve to prevent compressed air from being delivered from the compressor via the pneumatic line to the tank trailer.

13. A hydraulic system for off-loading liquids from tank trailers, comprising:
a housing having a frame;
a liquid pump secured on the frame and disposed at least partially within the housing, the liquid pump having a hydraulic motor in fluid communication with a hydraulic pump for operating the liquid pump;
a compressor secured on the frame and disposed at least partially within the housing, the compressor having a hydraulic motor in fluid communication with the hydraulic pump for operating the compressor; and
a hydraulic oil cooler in fluid communication with the hydraulic pump, the hydraulic motor of the liquid pump and the hydraulic motor of the compressor.

14. A hydraulic system according to claim 13, further comprising a selection and/or direction valve having an actuator handle for permitting an operator to select the operation of the hydraulic system between operating the liquid pump to off-load liquids that will not cause damage to the liquid pump and operating the compressor to off-load liquids that can potentially cause damage to the liquid pump.

15. A method for off-loading a liquid from a tank trailer into a storage container, the method comprising:
providing a hydraulic system comprising a housing with a liquid pump having a hydraulic motor and a hydraulic oil cooler disposed within the housing, the hydraulic motor of the liquid pump being in fluid communication with an external hydraulic pump and in fluid communication with the hydraulic oil cooler;
providing a first liquid conduit connected between the tank trailer and the liquid pump;
providing a second liquid conduit connected between the liquid pump and the storage container; and
operating the liquid pump to draw the liquid from the tank trailer via the first liquid conduit through the liquid pump and to pump the liquid via the second liquid conduit into the storage container.

16. A method according to claim 15, wherein the hydraulic system further comprises a compressor having a hydraulic motor disposed within the housing with the hydraulic motor of the compressor in fluid communication with the external hydraulic pump and with the hydraulic oil cooler.

17. A method according to claim 16, wherein the hydraulic system further comprises a selection and/or direction valve having an actuator handle for permitting an operator to select the operation of the hydraulic system between the liquid pump and the compressor.

18. A method for off-loading a liquid from a tank trailer into a storage container, the method comprising:
providing a hydraulic system comprising a housing with a compressor having a hydraulic motor and a hydraulic oil cooler disposed within the housing, the hydraulic motor of the compressor being in fluid communication with an external hydraulic pump and in fluid communication with the hydraulic oil cooler;
providing a pneumatic line connected between the compressor and the tank trailer;
providing a liquid conduit connected between the tank trailer and the storage container; and
operating the compressor to pressurize the tank trailer via the pneumatic line and to force the liquid from the tank trailer via the liquid conduit into the storage container.

19. A method according to claim 18, wherein the hydraulic system further comprises a liquid pump having a hydraulic motor disposed within the housing with the hydraulic motor of the liquid pump in fluid communication with the external hydraulic pump and with the hydraulic oil cooler.

20. A method according to claim 19, wherein the hydraulic system further comprises a selection and/or direction valve having an actuator handle for permitting an operator to select the operation of the hydraulic system between the compressor and the liquid pump.
